(19) United States
(12) Patent Application Publication
(10) Pub. No.: US 2018/0246526 A1
(43) Pub. Date: Aug. 30, 2018

(54) SYSTEMS AND METHODS FOR DELIVERING PRODUCTS VIA UNMANNED MOBILE LOCKERS

(71) Applicant: Wal-Mart Stores, Inc., Bentonville, AR (US)

(72) Inventors: Bruce W. Wilkinson, Rogers, AR (US); Todd D. Mattingly, Bentonville, AR (US)

(21) Appl. No.: 15/882,890

(22) Filed: Jan. 29, 2018

Related U.S. Application Data
(60) Provisional application No. 62/463,119, filed on Feb. 24, 2017.

(51) Int. Cl. G05D 1/02; G06Q 50/28; B60R 25/25; B60R 25/24; G08B 21/18

(52) U.S. Cl. CPC G05D 1/0291; G06Q 50/28; G05D 1/0278; G05D 2201/0207; B60R 25/246; G08B 21/182; B60R 25/25

(57) ABSTRACT

In some embodiments, methods and systems are provided that provide for facilitating delivery of products to delivery locations via unmanned mobile lockers deployed from mobile deployment stations.

### CROSS-REFERENCE TO RELATED APPLICATIONS

This application claims the benefit of U.S. Provisional Application No. 62/463,119, filed Feb. 24, 2017, which is incorporated herein by reference in its entirety.

### TECHNICAL FIELD

This invention relates generally to delivering products to delivery locations and, in particular, to delivering products to delivery locations via unmanned mobile lockers.

### BACKGROUND

A large portions of most large retailer's involves internet-based sales to consumers. Generally, the products purchased online by consumers are delivered to a physical address provided by the person who places the order, for example, a home address or a work address. Products delivered to a home address and left on the property are subject to being stolen and/or damaged (e.g., by people or weather) before the product is picked up by the intended recipient. On the other hand, delivering products to an office may be logistically difficult when large office buildings are involved, and may often be ineffective since the intended recipient may be busy and unable to accept delivery of the product, which undesirably forces a delivery service to either attempt to redeliver the product, or return the product to the retailer, increasing the delivery costs.

### BRIEF DESCRIPTION OF THE DRAWINGS

Disclosed herein are embodiments of systems, apparatuses, methods, and systems pertaining to delivering products to delivery locations via unmanned mobile lockers. This description includes drawings, wherein:

FIG. 1 is a diagram of a system for delivering products to delivery locations via unmanned mobile lockers deployed from a mobile deployment station in accordance with some embodiments;

FIG. 2 is a functional diagram of an exemplary computing device usable with the system of FIG. 1 in accordance with some embodiments; and

FIG. 3 is a flow chart diagram of a process of delivering products to delivery locations via unmanned mobile lockers in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods are provided for delivering products to delivery locations via unmanned mobile lockers deployed from mobile deployment stations.

In some embodiments, a system for delivering products to delivery locations via unmanned mobile lockers includes a deployment station configured to operatively couple to the unmanned mobile lockers, a plurality of unmanned mobile lockers configured to transport at least one product ordered to be delivered from the deployment location to a delivery location, and an electronic database including order data indicating the at least one product ordered to be delivered and the delivery location and unmanned mobile locker data indicating one or more of the unmanned mobile lockers available to deliver the at least one product to the delivery location. The system further includes a computing device including a processor-based control circuit configured to: obtain the order data and the unmanned mobile locker data from the electronic database; select, based on the obtained order data and the unmanned mobile locker data, an unmanned mobile locker from the plurality of unmanned mobile lockers at the deployment station to deliver the at least one product ordered to be delivered to the delivery location; transmit a delivery control signal to the selected unmanned mobile locker, the delivery control signal including delivery route instructions to guide the selected unmanned mobile locker from the deployment station to the delivery location along a delivery route determined by control circuit of the computing device; and transmit a return control signal to the selected unmanned mobile locker, the return control signal including return route instructions to guide the selected unmanned mobile locker from the delivery location to the deployment station along a return route determined by control circuit of the computing device.

In other embodiments, a method of delivering products to delivery locations via unmanned mobile lockers, the method including: providing a deployment station configured to operatively couple to the unmanned mobile lockers; providing a plurality of unmanned mobile lockers configured to transport at least one product from the deployment location to a delivery location; providing an electronic database including: order data indicating the at least one product ordered to be delivered and the delivery location; and unmanned mobile locker data indicating one or more of the unmanned mobile lockers available to deliver the at least one product to the delivery location; providing a computing device including a processor-based control circuit configured to: obtain the order data and the unmanned mobile locker data from the electronic database; select, based on the obtained order data and the unmanned mobile locker data, an unmanned mobile locker from the plurality of unmanned mobile lockers at the deployment station to deliver the at least one product ordered to be delivered to the delivery location; transmit a delivery control signal to the selected unmanned mobile locker, the delivery control signal including delivery route instructions to guide the selected unmanned mobile locker from the deployment station to the delivery location along a delivery route determined by control circuit of the computing device; and transmit a return control signal to the selected unmanned mobile locker, the return control signal including return route instructions to guide the selected unmanned mobile locker from the delivery location to the deployment station along a return route determined by control circuit of the computing device.

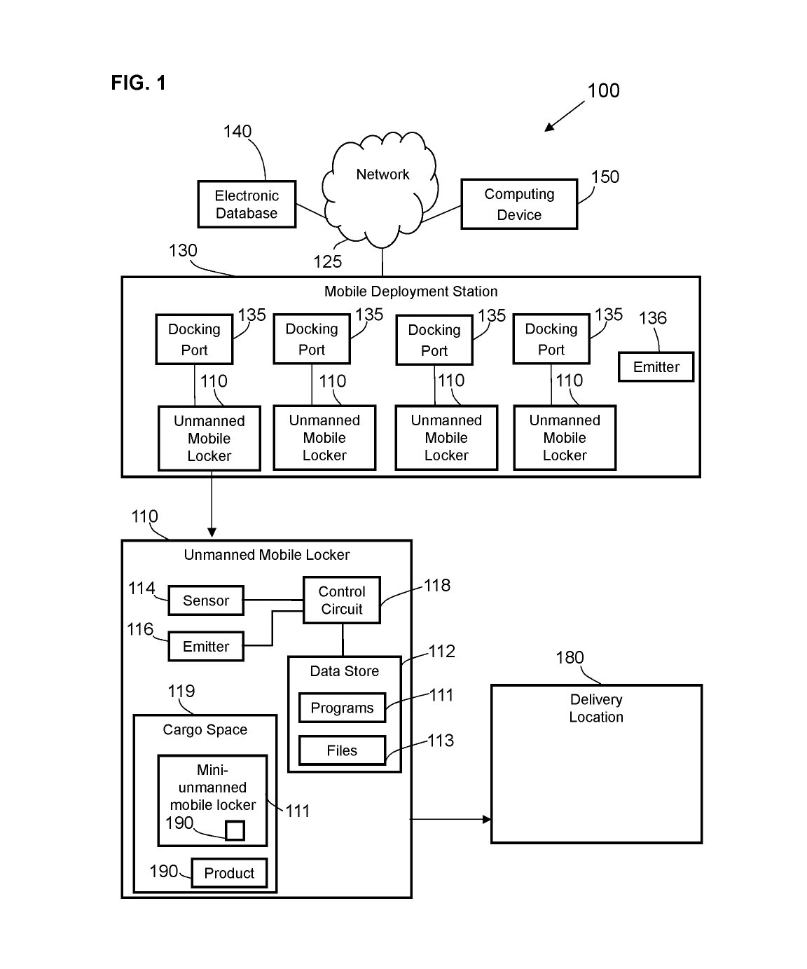

FIG. 1 shows an embodiment of a system 100 delivering products 190 ordered from a retailer to delivery locations 180 via unmanned mobile lockers 110. It will be understood that the details of this example are intended to serve in an illustrative capacity and are not necessarily intended to suggest any limitations in regards to the present teachings. The retailer may be any entity operating as a brick-and-mortar physical location and/or a website accessible, for example, via the internet or another network, by way of which products 190 may be ordered by a consumer (e.g., customer of the retailer). A customer may be an individual or business entity. Exemplary products 190 that may be ordered by consumers via the system 100 may include, but are not limited to, general-purpose consumer goods and consumable products (e.g., food items, medications, etc.).

In various embodiments, which will be described in more detail below, the components of the system 100 communicate with one another via a network 125. The network 125 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the system 100 includes an electronic database 140. In some embodiments, the electronic database 140 is configured to store information associated with customers of the retailer who order products 190 from the retailer. For example, the electronic database 140 may store electronic information including but not limited to: personal information of the customers, including payment method information, delivery address information and any known delivery access restrictions associated with the delivery location 180 designated, order data indicating one or more products 190 ordered for or by a customer and the designated delivery location 180; unmanned mobile locker data indicating one or more unmanned mobile lockers 110 available to deliver one or more products 190 to the delivery location 180, product order history, pending order status, product order options, as well as various product delivery options (e.g., indication of delivery method, authorized delivery recipients, etc.) of the customer of the retailer.

The electronic database 140 may be stored, for example, on non-volatile storage media (e.g., a hard drive, flash drive, or removable optical disk) internal or external to the computing device 150, or internal or external to computing devices separate and distinct from the computing device 150. It will be appreciated that the electronic database 140 may likewise be cloud-based. In some embodiments, the electronic database 140 is configured to store inventory management information associated with products 190 offered for sale to customers by a retailer. While one electronic database 140 is illustrated in FIG. 1, it will be appreciated that the electronic database 140 may include two separate databases, i.e., a separate customer information database and a separate inventory management database.

In some embodiments, when a customer initially sets up an online account with the retailer, the system 100 is configured to permit the customer to generate a customer profile including personal information of the customer (e.g., name, address, phone number, and the like), payment methods (e.g., credit card information), as well as product delivery settings of the customer (e.g., preferred delivery address and/or preferred delivery method). It will be appreciated that the customer may select new options and/or update previously selected options at any time after setting up the account with the retailer. In some embodiments, the personal information of the customer and any product delivery options selected by the customer are stored in the electronic database 140 for subsequent retrieval by the computing device 150 (e.g., in response to a login request by the customer, or in response to a product order placement by the customer).

The computing device 150 may be a stationary or portable electronic device, for example, a desktop computer, a laptop computer, a tablet, a mobile phone, or any other electronic device including a processor-based control circuit (i.e., control unit). For purposes of this specification, the term “computing device” will be understood to refer to a computing device owned by a retailer or any computing device owned and/or operated by an entity (e.g., manufacturer, delivery service, worker of the retailer, etc.) having an obligation to deliver products 190 to or for the retailer. In the embodiment of FIG. 1, the computing device 150 is configured for data entry and processing as well as for communication with other devices (e.g., electronic database 140, unmanned mobile lockers 110, mobile deployment station 130) of system 100 via the network 125. While the computing device 150 is shown in FIG. 1 as being separate from the mobile deployment station 130, it will be appreciated that, in some embodiments, the computing device 150 may be physically located within (e.g., installed at) the mobile deployment station 130.

In some embodiments, as will be described below, the computing device 150 is configured to communicate via the network 125 with one or more of the electronic database 140 and/or mobile deployment station 130 and/or unmanned mobile locker 110 to facilitate delivery of the products 190 to the delivery location 180. For example, in some embodiments, the computing device 150 is configured to transmit at least one signal to the mobile deployment station 130 to provide the mobile deployment station 130 with GPS coordinates of the delivery location 180. In some embodiments, the computing device 150 is configured to transmit at least one signal to the unmanned mobile locker 110 to cause the unmanned mobile locker 110 to move toward and/or away from the delivery location 180 in order to transport, pick up, and/or drop off a product 190 or products 190 ordered by or for the customer of the retailer.

In some embodiments, the computing device 150 is configured to cause the unmanned mobile locker 110 to travel to a delivery location 180, to wait a predetermined time at the delivery location 180, and to permit the customer (or another authorized recipient) to retrieve the products 190 from the unmanned mobile locker 110, for example, after verification of the recipient's identity by the unmanned mobile locker 110 (or by the computing device 150). In some embodiments, the computing device 150 may be configured to determine whether one or more product pick/up and/or drop off conditions for the unmanned mobile locker 110 are met prior to instructing the unmanned mobile locker 110 to move into a product unloading position at the delivery location 180 and to unlock a cargo space 119 of the unmanned mobile locker 110 in order to permit an authorized delivery recipient to retrieve one or more products 190 therefrom.

The exemplary mobile deployment station 130 depicted in FIG. 1 is generally a vehicle configured traverse one or more intended environments in accordance with one or more routes and/or determined paths and configured to operatively couple to the unmanned mobile lockers 110. The mobile deployment station may be operated by a human operator or may be an autonomous ground vehicle that is remotely controlled by a computing device (e.g., computing device 150). In the embodiment illustrated in FIG. 1, the mobile deployment station 130 a plurality of docking ports 135 configured to permit the unmanned mobile lockers 110 to dock thereto and charge. The exemplary mobile deployment station 130 of FIG. 1 includes an emitter (e.g., a transceiver) 136 configured to communicate, for example, with the computing device 150 and/or with the unmanned mobile lockers 110 and/or with electronic database 140. In one aspect, the mobile deployment station 130 is configured to provide power and/or coolant for controlling the temperature within the cargo space 119 of the unmanned mobile lockers 110 when the unmanned mobile lockers 110 are coupled to the docking ports 135 of the mobile deployment station 130.

In some aspects, the mobile deployment station 130 is configured to automatically load products 190 into one or more unmanned mobile lockers 110 selected (e.g., by the computing device 150) for transporting the products 190 to one or more delivery locations 180. In other aspects, products 190 can be pre-loaded into the unmanned mobile lockers 110 that are loaded into the mobile deployment station 130, for example, at a product distribution facility of a retailer. In some embodiments, the mobile deployment station 130 is configured to deploy unmanned mobile lockers 110 therefrom to their respective delivery locations 180 and to receive unmanned mobile lockers returning to the mobile deployment stations from their respective delivery locations 180. For example, the mobile deployment station 130 may include a ramp that permits the unmanned mobile lockers to deploy from the interior of the mobile deployment station onto a street surface.

The unmanned mobile locker 110 is generally a robot or a vehicle configured to autonomously traverse one or more intended environments in accordance with one or more routes and/or determined paths, and typically without the intervention of a human or a remote computing device while retaining one or more products 190 in the cargo space 119 thereof, and delivering the products 190 to the delivery locations 180. In some instances, however, a remote operator or a remote computer (e.g., computing device 150) may temporarily or permanently take over operation of the unmanned mobile locker 110 using feedback information from the unmanned mobile locker 110 (e.g., audio and/or video content, sensor information, etc.) communicated to a remote navigation center and/or central control system (e.g., via network 125 or other similar distributed network). In some embodiments, the unmanned mobile lockers 110 are configured as mobile mini-deployment stations in that the cargo space 119 of each of the unmanned mobile lockers is configured to operatively couple to one or more mini unmanned mobile lockers 111 that store a product 190 therein and have a reduced size as compared to the unmanned mobile lockers 110 transported in and deployed from the mobile deployment station 130. While only one mini unmanned locker 111 is illustrated in FIG. 1, it will be appreciated that the cargo space 119 of the unmanned mobile locker 110 is configured in some embodiments to operatively couple to (e.g., via docking ports 135) to 2, 3, 4, or more mini unmanned lockers 111. In one aspect, after the unmanned mobile locker 110 is deployed from the mobile deployment station 130, the unmanned mobile locker 110 may itself deploy one or more mini unmanned lockers 111 from the cargo space 119 thereof, such that one or more deployed mini unmanned lockers navigate to the delivery location 180 and, after delivering the products 190 retained therein, return and operatively couple (e.g., via a docking port 135, etc.) to the cargo space 119 for recharging. In some embodiments, the mini unmanned lockers 111 are guided in their navigation to the delivery location 180 via control signals transmitted by the control circuit 118 of the unmanned mobile locker 110. In other embodiments, the mini unmanned lockers 111 are guided in their navigation to the delivery location 180 via control signals transmitted by the control circuit 210 of the computing device 150.

While only four unmanned mobile lockers 110 are shown in FIG. 1 for ease of illustration, it will be appreciated that in some aspects, the system 100 may include any number of unmanned mobile lockers 110, and the computing device 150 may simultaneously communicate with and/or transmit route instructions to more than one (e.g., 5, 10, 50, 100, 1000, or more) unmanned mobile lockers 110 simultaneously to guide the unmanned mobile lockers 110 along the routes determined by the computing device 150 in order to transport products 190 to their respective delivery locations 180. Similarly, while only one mobile deployment station 130 is depicted in FIG. 1 for ease of illustration, it will be appreciated that in some aspects, the computing device 150 communicates with two or more mobile deployment stations 130 (e.g., 5, 10, 50, 100, 1000, or more) at different locations, for example, to obtain GPS coordinates of mobile deployment stations 130, or to guide the mobile deployment stations 130 to their delivery locations 180.

The exemplary unmanned mobile locker 110 of FIG. 1 includes one or more data stores 112, sensors 114, and emitters 116 each in communication with one or more control circuits 118. In some embodiments, emitter 116 and sensor 114 are implemented together through a single device. The unmanned mobile locker 110 deployed in some embodiments of the exemplary system 100 does not require physical operation by a human operator and wirelessly communicates with, and is wholly or largely controlled by, the computing device 150. For example, the computing device 150 may control directional movement of the unmanned mobile locker 110 to a delivery location 180 based on a variety of inputs. In some approaches, the control circuit 118 of the unmanned mobile locker 110 is programmed with GPS coordinates of the delivery location 180 where the product 190 is to be delivered, and is configured to determine a route of the unmanned mobile locker 110 to the delivery location 180 and to cause the unmanned mobile locker 110 to move toward the delivery location 180 without receiving remote signals (e.g., route instructions) from the computing device 150.

In some embodiments, the emitter 116 is configured as a two-way transceiver that can receive the route instructions transmitted from the computing device 150 and that can send one or more signals to the computing device 150. For example, the computing device 150 may be configured to analyze GPS coordinates of the physical location of the delivery location 180 where the products 190 are to be delivered, to determine a route for the unmanned mobile locker 110 to the delivery location 180, and to transmit to the unmanned mobile locker 110 a signal via the network 125 including route instructions to guide the unmanned mobile locker 110 to the delivery location 180 along the determined route. In turn, the unmanned mobile locker 110, upon receipt of such a signal from the computing device 150, is configured to navigate, based on the route instructions, to the delivery location 180 while retaining the products 190 to be delivered therein.

In some embodiments, the emitter 116 of the unmanned mobile locker 110 is configured to transmit, via the network 125, a signal including an electronic confirmation that the product 190 ordered by or for a customer of the retailer has been delivered by the unmanned mobile locker 110 to the designated delivery location 180. In one approach, in response to receipt from the unmanned mobile locker 110 of the electronic confirmation that the product 190 has been delivered to the delivery location 180, the computing device 150 is configured to transmit (e.g., to a personal electronic device of a customer or authorized intended delivery recipient) an electronic alert that the product 190 has been delivered to the delivery location 180. In some configurations, based on a delivery control signal including route instructions or a separate signal received from the computing device 150, the unmanned mobile locker 110 is configured to remain at the delivery location 180 while retaining the products 190 therein for a period of time indicated in the route instructions or in the separate control signal.

In some embodiments, the unmanned mobile locker 110 is configured to, in response to either a control signal from the computing device 150, or a verification code entered by the intended recipient, to permit the intended recipient to retrieve the products 190 from an interior cargo space 119 of the unmanned mobile locker 110. In some embodiments, the emitter 116 of the unmanned mobile locker 110 is configured to transmit a verification input entered by the intended recipient (e.g., a customer or person authorized by the customer) at the delivery location 180 to the computing device 150, and the computing device 150 is configured to authenticate the intended recipient based on the verification input received by the computing device 150 from the unmanned mobile locker 110. In some aspects, the computing device 150 is configured to transmit an access signal to the unmanned mobile locker 110 indicating that the verification input entered by the recipient was accepted, and the unmanned mobile locker 110, in response to receipt of the access signal from the computing device 150, is configured to unlock the lockable cargo space 119 and permit the intended recipient to retrieve product 190 therefrom.

According to some embodiments, the emitter 116 of the unmanned mobile locker 110 is also configured to transmit, via the network 125, a confirmation signal including an electronic confirmation that the product 190 has been retrieved by the customer (or a person authorized by the customer) from the cargo space 119 of the unmanned mobile locker 110 at the delivery location 180. In some approaches, in response to receipt of such an electronic confirmation from the unmanned mobile locker 110, the computing device 150 is configured to transmit a return control signal including return route instructions to the unmanned mobile locker 110 to guide the unmanned mobile locker 110 back to the mobile deployment station 130, and to couple to an available docking port 135 of the mobile deployment station 130 for recharging.

In some embodiments, the unmanned mobile locker 110 includes one or more propulsion systems (e.g., motors, wheels, tank treads, etc.) that enable the unmanned mobile locker 110 to at least accelerate, deaccelerate, and/or traverse an environment using a navigation coordinate system, such as GPS, coordinate mapping information, beacon location information, cellular signal triangulation, other navigation systems and/or information, or a combination of two or more of such navigation systems and/or information. Further, the navigation coordinate system can be configured to provide location information, and in some instances time information.

In some embodiments, the emitter 116 of the unmanned mobile locker 110 is configured to transmit GPS coordinates of the physical location of the unmanned mobile locker 110 to the computing device 150 (and/or to the mobile deployment station 130). In one aspect, the computing device 150 is configured to obtain the GPS coordinates of the physical location of the unmanned mobile locker 110 based on the GPS coordinates transmitted to the computing device 150 via the emitter 116 of the unmanned mobile locker 110. Similarly, in some aspects, the mobile deployment station 130 includes an emitter 136 (e.g., a transceiver) configured to transmit GPS coordinates of the physical location of the mobile deployment station 130 to the computing device 150, such that the computing device 150 obtains the GPS coordinates of the physical location of the mobile deployment station 130 based on the GPS coordinates transmitted to the computing device 150 from the emitter 136 of the mobile deployment station 130. As such, the computing device 150 is configured to include real-time information regarding the locations of the mobile deployment station 130 and each of the unmanned mobile lockers 110.

In some embodiments, the unmanned mobile locker 110 is configured to operate in different weather conditions, and/or can be readily modified depending on expected weather conditions (e.g., wheels replaced with tank treads when it is anticipated that the unmanned mobile locker 110 may encounter snow and/or ice). The unmanned mobile locker 110 can, in some applications, be further configured to communicate with and/or physically couple to other unmanned mobile lockers 110 (e.g., to facilitate recharging and/or communiation with computing device 150), transport vehicles (e.g., mobile deployment station 130), multiple different types of computing devices (e.g., computing device 150) other computing devices, remote databases (e.g., electronic database 140), and/or other electronic devices.

In some embodiments, the emitter 116 of the unmanned mobile locker 110 is a wired or a wireless transceiver configured to convey information, notifications, warnings and/or deterrents to a customer, a worker of the retailer, a potential threat (e.g., animal, person that is a potential threat), unknown third party, a remote central control system, a security service, a municipal police service, other such entities, or combination of two or more of such entities. The emitter 116 can comprise one or more output devices (e.g., speakers, displays, whistles, buzzers, lights and similar items) that convey text, audio, and/or visual signals. In some embodiments, emitter 116 can be configured to convey notifications having textual, audible and/or visual content. Similarly, the emitter 116 may additionally or alternatively be configured to facilitate wireless data communications with a computing device, including but not limited to, computing device 150.

In some embodiments, the emitter 116 may be configured to emit one or more irritants. For example, an “irritant” can include one or more stimuli or agents that can cause a “hostile” person, animal, or the like to not touch or tamper with the unmanned mobile locker 110 and/or to remove themselves from a predetermined perimeter about the unmanned mobile locker 110. Applicable irritants can include chemical, audible, visual irritants, or combination of two or more such irritants. In some embodiments, the emitter 116 can comprise one or more reservoirs, pumps, nozzles, motors, compressed gas, etc. that can be used to eject and/or adjust the direction of emission of the irritant. Additionally or alternatively, the output devices of the emitter 116 may include one or more speakers, whistles, buzzers, and the like that can be activated to generate one or more warnings (e.g., that may gradually increase in volume) audible irritants, and/or deterrent noises. Audible irritants can be substantially any relevant audible noise that can provide an alert, warn and/or deter interaction with the unmanned mobile locker 110. For example, audible irritants can include audible sounds within a frequency range of about 2 kHz to about 5 kHz, canine-specific audible sounds, sounds having a volume greater than one or more thresholds, audible alerts that can be understood by a person, and/or other such audible alerts and/or irritants.

In some instances, one or more emitters 116 enable the unmanned mobile locker 110 to progressively escalate the deterrent effect of the deterrent and/or irritant. For example, the unmanned mobile locker 110 may initiate the generation of an audible alert when a human, animal, automobile, or the like is detected within a first threshold distance (which may depend on a speed at which the animal, person, automobile, etc. is approaching), increase the volume of the audible alert when within a second threshold distances (less than the first threshold distance), spray one or more streams of water when within a third threshold distance (less than the second distance), and spray prepper spray when within a fourth threshold distance for more than a threshold period of time and/or contacts the unmanned mobile locker 110.

The exemplary unmanned mobile locker 110 further includes one or more sensors 114. The sensors 114 can include substantially any relevant device that provides information to the unmanned mobile locker 110 to be used in navigation, intended recipient detection and/or authentication, threat detection, distance measurements, environment mapping, location determination, and/or other such information. The sensor 114 may include one or more devices that can be used to capture data related to one or more objects located within a threshold distance relative to the unmanned mobile locker 110. For example, the unmanned mobile locker 110 includes at least one sensor 114 configured to detect at least one obstacle between the unmanned mobile locker 110 and the delivery location 180 along the route determined by the computing device 150 for the unmanned mobile locker 110. Based on the detection of one or more obstacles by such a sensor 114, the unmanned mobile locker 110 is configured to avoid the obstacle(s).

In some embodiments, one or more sensors 114 can be included and/or cooperated with the unmanned mobile locker 110 that include, but are not limited to, one or more sensors to detect an object within one or more threshold or predetermined distances of the unmanned mobile locker 110, capture data within a threshold distance relative to unmanned mobile locker 110, detect movement, measure temperature (in the cargo space 119 or ambient temperature), capture images and/or video, capture thermographic, infrared, and/or multi spectral images, capture images of entities attempting to tamper with unmanned mobile locker 110, one or more accelerometers, one or more gyroscopes, one or more odometers, one or more location sensors, one or more microphones (e.g., which can be configured to capture audible authentication codes and/or voice prints, threatening language, verbal input from customers, verbal inquiries from customers, etc.), one or more distance measurement sensors (e.g., laser sensors, sonar sensors, sensors that measure distance by emitting and capturing a wireless signal (which can comprise light and/or sound) etc.), 3D scanning sensors, other such sensors, or a combination of two or more of such sensors.

In some aspects, the unmanned mobile locker 110 includes one or more sensors 114 in communication with one or more access panels (that cover cargo space 119) of unmanned mobile locker 110 and/or positioned adjacent to such access panels to sense when such panels are tampered with. The exemplary unmanned mobile locker 110 of FIG. 1 includes a lockable cargo space 119 configured to retain one or more products 190. In some aspects, the lockable cargo space 119 is configured to be unlocked in response to a verification input by a customer of the retailer who placed the order for the products 190 (or a person authorized to pick up the products 190) at the delivery location 180. As discussed below, the verification input can be a verification code, biometric scan, a verbal password, or the like.

In some embodiments, the unmanned mobile locker 110 includes one or more sensors 114 configured to detect the temperature in the cargo space 119 of the unmanned mobile locker 110 and coupled to one or more controllers configured to raise or lower the temperature of the cargo space 119 of the unmanned mobile locker 110 in order to preserve the freshness and/or desired texture and/or desired consumption temperature of one or more products 190 stored therein. For example, in some aspects, the cargo space 119 of the unmanned mobile locker 110 is a refrigerator that holds a variety of consumer beverages at a consumer-desired consumption temperature of 34° F., and the sensors 114, in response to detecting that the temperature within the cargo space 119 is above 34° F., are configured to cause activation of a temperature controller that decreases the temperature in the cargo space 119 to 34° F. or below to preserve the consumer beverages at their desired consumption temperature. In some embodiments, the cargo space 119 of the unmanned mobile locker 110 is a freezer that holds a frozen food such as ice cream at a temperature of 32° F., and the sensors 114, in response to detecting that the temperature within the cargo space 119 is above 32° F., are configured to cause activation of a temperature controller that decreases the temperature in the cargo space 119 to 32° F. or below to prevent the ice cream from melting and to preserve the desired texture of the ice cream.

In some embodiments, the unmanned mobile lockers 110 of the system 100 are configured for transporting perishable products 190 in their cargo space 119. In one aspect, the unmanned mobile lockers 110 include one or more sensors 114 configured to detect that one or more perishable product(s) 190 stored in the cargo space 119 has spoiled. For example, the unmanned mobile lockers 110 can include one or more sensors 114 configured to detect one or more gases associated with one or more perishable products 190 (e.g., seafood, meat, dairy, or the like) stored in the cargo space 119 of the unmanned mobile locker 110 that, when released by such perishable products 190, indicate that one or more of the perishable product(s) 190 has spoiled.

In some embodiments, one or more data stores 112 provide an information repository that typically stores programs 111 and files 113. The unmanned mobile locker 110 may, in some embodiments, further access one or more programs 111, files 113, and/or other relevant information external to unmanned mobile locker 110 and accessible via network 125. Files 113 can comprise information transmitted by the computing device 150, data captured by the sensor 114, customer and/or authorized delivery recipient information, customer identifier information, computing device identifier information, product information, customer order information, navigation and/or routing information, location information, mapping information, unmanned mobile locker identifier information, communication procedures, threat information, sensor data, images, video, historic information, and/or other such information, and/or other such information. For example, in some embodiments, files 113 can further comprise one or more notification templates, which are software used by the unmanned mobile lockers 110 as a basis to convey salutations and/or advertisements to customers and/or pedestrians located within a threshold distance relative to the unmanned mobile lockers 110. Notification template's content may at least be provided by product manufacturers and/or owners of the unmanned mobile lockers 110. In some embodiments, notification templates may further be personalized using customer's specific information to, for example, target a specific customer and increase engagement between the customer and the unmanned mobile locker 110.

Personalized notifications can reference a customer's product order history, current needs, anticipated needs, and/or similar information that can increase the probability that the customer makes desired product and/or service purchases. Commercial product information and/or customer-specific information may be added to notification templates in real-time prior to their transmission by the unmanned mobile lockers 110 when the presence of customer, authorized delivery recipient, and/or pedestrians is detected by the unmanned mobile lockers 110.

Commercial product information can include, for example, product names, product types, manufacturer names, manufacturer origin, ingredient names, ingredient types, component names, and/or component types. Notification templates can comprise audio and/or visual components, for example, music, speech, tones, images, and/or video. Files 113 can further comprise personal and/or non-public information about the customers, including but not limited to, information about browser history, location, birthdays, delivery dates, spouses, pets, and/or heirs associated with the customers and other authorized intended delivery recipients. Files 113 can comprise predetermined biometric data associated with the customers, which can be used for authentication purposes, and/or determining unknown and/or hostile third parties. Applicable biometric data can include, but is not limited to voice prints, iris patterns, retina-patterns, hand geometries, earlobe geometries, facial landmarks, thermographic signatures, vascular patterns, skin texture data points, and/or walking gate data points. Predetermined biometric data can include data captured by the sensors 114, provided by the customers, external sensors, and/or received from an external central computing system.

As described above, the unmanned mobile locker 110 further includes programs 111 that are stored in the data store 112 and/or other memory, and utilized at least by the one or more control circuits 118. In some applications, one or more of the programs 111 are software that are executed by the one or more control circuits 118 to facilitate the operation, control, commercial activity, interaction with customers, deterring potential danger and the like to the unmanned mobile locker 110. For example, the one or more control circuits 118, in executing one or more programs 111, can use data generated by sensors 114 to detect when customers or hostile third parties are positioned within a threshold distance relative to the unmanned mobile lockers 110, generate notifications in response to detecting the presence of customers and/or hostile third parties, as well as generate notifications in response to receiving triggering events from the computing device 150. For example, the presence of customers or authorized intended delivery recipients positioned within threshold distances relative to unmanned mobile lockers 110 can be confirmed using geolocation data, which reflects the locations of the customers or the authorized intended delivery recipients, received from the computing device 150 (e.g., based on GPS data obtained from a mobile phone of the customer or intended recipient).

Hostile third parties can refer to any human or animal or vehicle attempting to interfere with the operation of unmanned mobile locker 110, which may, for example, be characterized as any attempts to gain unauthorized access to the cargo space 119 of the unmanned mobile locker 110, attempts to gain unauthorized access to the software and/or hardware of the unmanned mobile locker 110, attempts to gain unauthorized access to products 190 being transported by the unmanned mobile locker 110, attempts to damage the unmanned mobile locker 110, attempts to obstruct the travel path of unmanned mobile locker 110, and/or other activities detrimental to or interfering with the unmanned mobile locker 110.

Additionally or alternatively, control circuit 118, in executing one or more programs 111, can generate one or more types of biometric data (discussed above) using information captured via sensor 114, and determine whether the generated biometric data has one or more threshold relationships to predetermined biometric data included in files 113, wherein generated biometric data having threshold relationships identify customers and such data lacking the threshold relationships identify unknown and/or hostile third parties.

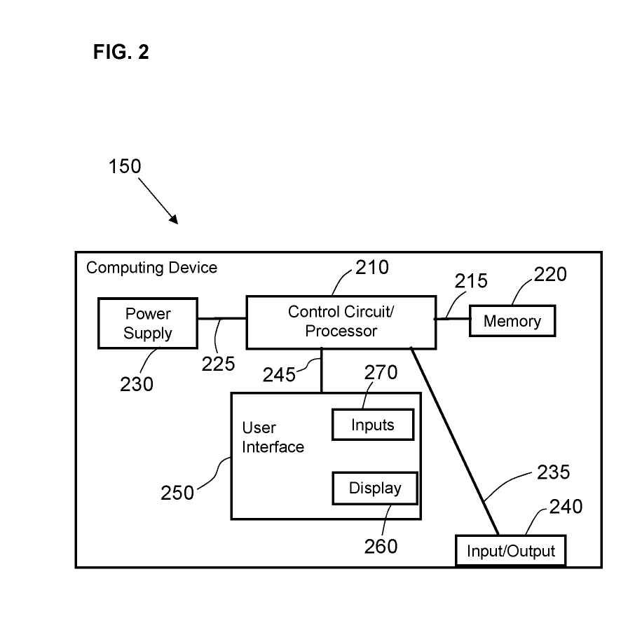

With reference to FIG. 2, an exemplary computing device 150 configured for use with the systems and methods described herein may include a control circuit or control unit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 of the computing device 150 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 210 of the computing device 150 is also electrically coupled via a connection 235 to an input/output 240 that can receive signals from any source (e.g., unmanned mobile locker 110, mobile deployment station 130, etc.) that can communicate with the computing device 150 via a wired or wireless connection. The input/output 240 of the computing device 150 can also send signals to the unmanned mobile locker 110, mobile deployment station 130, or to any other device in wired or wireless communication with the computing device 150.

In the embodiment shown in FIG. 2, the processor-based control circuit 210 of the computing device 150 is electrically coupled via a connection 245 to a user interface 250, which may include a visual display or display screen 260 (e.g., LED screen) and/or button input 270 that provide the user interface 250 with the ability to permit an operator of the computing device 150 to manually control the computing device 150 by inputting commands via touch-screen and/or button operation and/or voice commands to, for example, to communicate with the unmanned mobile locker 110, mobile deployment station 130, electronic database 140, or the like. It will be appreciated that the performance of such functions by the processor-based control circuit 210 of the computing device 150 is not dependent on a human operator, and that the control circuit 210 may be programmed to perform such functions without a human operator.

In some embodiments, the display screen 260 of computing device 150 is configured to display various graphical interface-based menus, options, and/or alerts that may be transmitted to the computing device 150 and displayed on the display screen 260 in connection with various aspects of the order placed by or for the customer. The inputs 270 of the computing device 150 may be configured to permit an operator to navigate through the on-screen menus on the computing device 150 and make changes and/or updates to the delivery location 180. It will be appreciated that the display screen 260 may be configured as both a display screen and an input 270 (e.g., a touch-screen that permits an operator to press on the display screen 260 to enter text and/or execute commands.)

In some embodiments, the control circuit 210 of the computing device 150 is programmed to determine that one or more products 190 ordered by or for a customer is to be delivered to a delivery location having a defined physical address. In some aspects, the control circuit 210 of the computing device 150 is programmed to authorize commencement of a delivery attempt of the product 190 to the customer (or a customer-specified intended recipient) after verification that the delivery location 180 has been properly identified (e.g., that GPS coordinates of the delivery location 180 have been obtained). In one aspect, prior to, or after the commencement of the delivery attempt of one or more products 190 to the delivery location 180, the control circuit 210 of the computing device 150 is programmed to obtain the GPS coordinates associated with the delivery location 180 from the electronic database 140 (where such information may be stored in association with the customer).

In some embodiments, when the delivery of the product 190 via the unmanned mobile locker 110 is in progress, and more specifically, after the unmanned mobile locker 110 has arrived at the delivery location 180, the control circuit 210 is configured to receive, via the network 125, an authentication of an identity of the customer (or of an authorized person accepting delivery of the product 190 on behalf of the customer, or a customer-designated intended recipient) attempting to retrieve the product 190 from the unmanned mobile locker 110. In one aspect, the sensor 114 of the unmanned mobile locker 110 may include a video camera configured to visually inspect a physical identification card (e.g., Driver's License) of the customer or person accepting delivery on behalf of the customer and generate identity detection data. The emitter 116 of the unmanned mobile locker 110 may then transmit such identity detection data over the network 125 to the computing device 150, after which the control circuit 210 of the computing device 150 is configured to obtain (e.g., from the electronic database 140) authentic identification data associated with the customer or authorized person to determine whether there is a match.

The control circuit 210 is further configured to send a return signal (via the input/output 240) to the unmanned mobile locker 110 to instruct the unmanned mobile locker 110 as to whether or not to grant access to the cargo space 119 of the unmanned mobile locker 110 to the customer (or another person attempting to accept the delivery) based on whether the identity detection data associated with the customer (or the other person attempting to accept delivery) matched authentic identification data stored in the electronic database 140. In some embodiments, the control circuit 210 is configured to authorize (e.g., via a transmission of a signal over the network 125 to the unmanned mobile locker 110) the unmanned mobile locker 110 to unlock the cargo space 119 and permit the customer or authorized person to retrieve the product 190 from the cargo space 119 based on the authentication of the identity of the customer or authorized person, which may be performed as described above. In one aspect, upon a successful completion of a delivery of the product 190 to the customer or a customer-authorized person at the delivery location 180, the control circuit is 210 of the computing device 150 is configured to receive, over the network 125, from a mobile device of the customer or customer-authorized intended recipient, an electronic notification that the product 190 has been successfully delivered.

In some embodiments, the control circuit 210 of the computing device 150 is programmed to generate various customer alerts in connection with the delivery of the products 190 to the customer or customer-designated delivery recipient. Such alerts may include but are not limited to an alert indicating that the unmanned mobile locker 110 has arrived at the delivery location 180, or an alert indicating that the unmanned mobile locker 110 was unable to successfully access the delivery location 180. In some embodiments, customer alerts sent by the computing device 150 to an electronic device of a customer (or customer-designated delivery recipient) include but are not limited to short message service (SMS) messages, electronic mail (e-mail) messages, instant messenger messages, voice mail messages, and/or mobile app push notifications.

In some embodiments, the control circuit 210 of the computing device 150 is programmed to obtain, via the network 125, order data and unmanned mobile locker data from the electronic database 140. For example, order data may include, but is not limited to the name of a customer or an authorized person to whom delivery is to be made, and a physical address and/or GPS coordinates of the delivery location 180. The unmanned mobile locker data may include, but is not limited to a total number of unmanned mobile lockers 110 located at the mobile deployment station 130 and available for delivering products 190 to the delivery location 180; a charge level of each of the unmanned mobile lockers 110 coupled to a docking port 135 of the mobile deployment station 130; inventory retained in and/or load carrying capacity of the unmanned mobile lockers 110 located at the mobile deployment station 130; and/or pending tasks assigned to unmanned mobile lockers 110 located at, or deployed from, the mobile deployment station 130.

In one aspect, the control circuit 210 of the computing device 150 is programmed to select, based on the obtained order data and the unmanned mobile locker data, an unmanned mobile locker 110 from the unmanned mobile lockers 110 at the mobile deployment station 130, to deliver one or more products 190 to the delivery location 180. For example, in some configurations, after the control circuit 210 selects, based on an analysis of the obtained order data and the unmanned mobile locker data, an unmanned mobile locker 110 that will be tasked with effectuating a delivery, the control circuit 210 is configured to transmit a delivery control signal to the selected unmanned mobile locker 110. In one aspect, the delivery control signal includes delivery route instructions to guide the selected unmanned mobile locker 110 from the mobile deployment station 130 to the delivery location 180 (designated by the customer or another person, or determined by the computing device 150) along a delivery route determined by control circuit of the computing device 150. In some embodiments, where the unmanned mobile lockers 110 are configured as mobile mini-deployment stations in that the cargo space 119 of each of the unmanned mobile lockers is configured to operatively couple to and to deploy therefrom one or more mini unmanned mobile lockers 111, the control circuit 210 of the computing device 150 is configured to transmit a delivery control signal to the mini unmanned lockers 111 deployed from the unmanned mobile lockers 110 such that the mini unmanned lockers 111 are guided in their navigation to the delivery location 180 via the delivery control signal transmitted by the control circuit 210 of the computing device 150.

In addition, the control circuit 210 of the computing device 150 is configured to transmit a return control signal to the selected unmanned mobile locker 110 in order to guide the unmanned mobile locker 110 from the delivery location 180 back to the mobile deployment station 130. In one aspect, the return control signal includes return route instructions to guide the selected unmanned mobile locker 110 from the delivery location 180 to the mobile deployment station 130 along a return route determined by control circuit of the computing device 150. In some embodiments, the control circuit 210 of the computing device 150 is programmed to generate and transmit the return control signal to the unmanned mobile locker 110 that delivered the products 190 to the delivery location 180 after receiving, over the network 125, an electronic confirmation (e.g., from the unmanned mobile locker 110 or an electronic device of the person accepting delivery) that the products 190 were successfully retrieved from the unmanned mobile locker 110 by the customer or another authorized person at the delivery location 180.

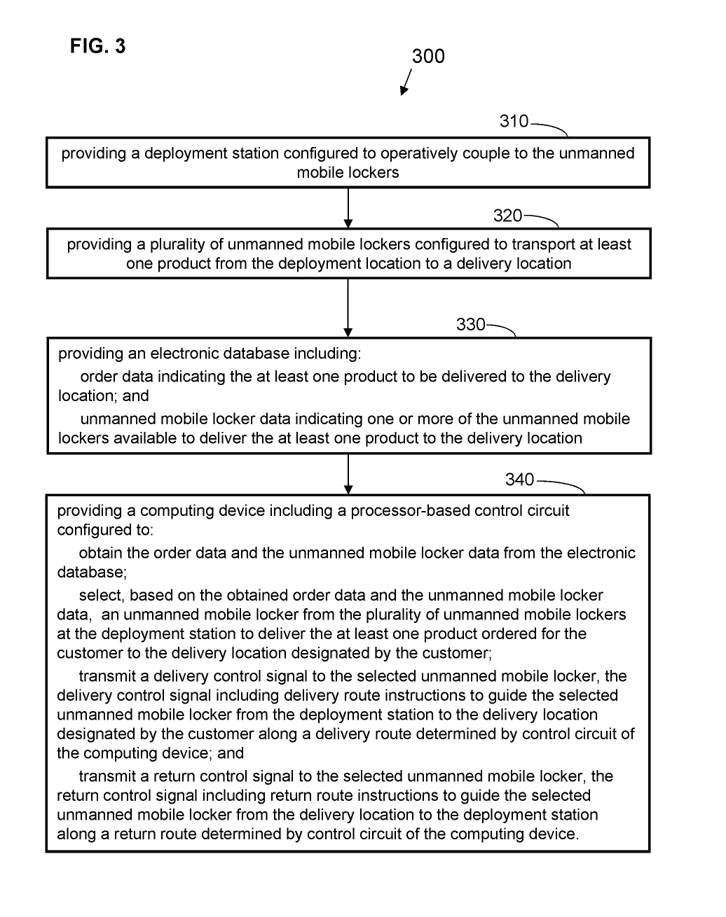

FIG. 3 shows an embodiment of an exemplary method 300 of delivering products 190 to delivery locations 180 via unmanned mobile lockers 110. The embodiment of the method 300 illustrated in FIG. 3 includes providing a deployment station 130 configured to operatively couple to the unmanned mobile lockers 110 (step 310). As discussed above, in some configurations, the deployment station 130 is a mobile station (e.g., mounted on a vehicle driven by a human operator or configured as an autonomous ground vehicle). The exemplary mobile deployment station 130 of FIG. 1 includes a plurality of docking ports 135 configured to permit the unmanned mobile lockers 110 to dock thereto and charge. As discussed above, while FIG. 1 the mobile deployment station 130 retaining only four unmanned mobile lockers 110, the mobile deployment station 130 can house 5, 10, or more unmanned mobile lockers 110 in some configurations. In addition, while only one mobile deployment station 130 is shown in FIG. 1, it will be appreciated that two or more mobile deployment stations 130 can be simultaneously used.

In some aspects, the mobile deployment station 130 is configured such that the unmanned mobile lockers 110, when coupled to the docking ports 135 of the mobile deployment station 130, can be loaded with products 190 to be delivered to the delivery location 180. Similarly, the mobile deployment station 130 can be configured such that the unmanned mobile lockers 110, when coupled to the docking ports 135 of the mobile deployment station 130, can be unloaded (e.g., if dropping off products 190 at the delivery location 180 was not successful). In some aspects, the mobile deployment station 130 provides power and/or coolant for controlling the temperature within the cargo space 119 of the unmanned mobile lockers 110 when the unmanned mobile lockers 110 are coupled to the docking ports 135 of the mobile deployment station 130.

The exemplary method 300 of FIG. 3 further includes providing a plurality of unmanned mobile lockers 110 configured to transport one or more products 190 from the mobile deployment station 130 to a delivery location 180 (step 320). In addition, the exemplary method 300 of FIG. 3 further includes providing an electronic database 140 including: (1) order data indicating one or more products 190 to be delivered to the delivery location 180; and (2) unmanned mobile locker data indicating one or more unmanned mobile lockers 110 available to deliver the product(s) 190 to the delivery location 180 (step 330).

The exemplary method 300 of FIG. 3 further includes providing a computing device 150 including a processor-based control circuit 210 and configured to: obtain the order data and the unmanned mobile locker data from the electronic database 140; select, based on the obtained order data and the unmanned mobile locker data, an unmanned mobile locker 110 from the unmanned mobile lockers 110 at the deployment station 130 to deliver one or more products 190 to the delivery location 180; transmit a delivery control signal to the selected unmanned mobile locker 110, with the delivery control signal including delivery route instructions to guide the selected unmanned mobile locker 110 from the deployment station 130 to the delivery location 180 along a delivery route determined by control circuit 210 of the computing device 150; and transmit a return control signal to the selected unmanned mobile locker 110, with the return control signal including return route instructions to guide the selected unmanned mobile locker 110 from the delivery location 180 to the deployment station 130 along a return route determined by control circuit 210 of the computing device 150 (step 340).

In some aspects, the computing device 150, which may be installed at the mobile deployment station 130, or may be located remotely to the mobile deployment station 130 (and in communication with the mobile deployment station 130 over the network 125), selects one of the unmanned mobile lockers 110 to deliver one or more products 190 to the delivery location 180 based on the order data and unmanned mobile locker data obtained from the electronic database 140. For example, after obtaining, from the electronic database 140, order data identifying the intended delivery recipient, the product(s) 190 to be delivered to the intended recipient, and the delivery location 180, the control circuit 210 of the computing device 150 is programmed to obtain from the electronic database 140 and analyze unmanned mobile locker data in order to determine which one of the unmanned mobile lockers 110 is best suited to effectuate the delivery of the product(s) 190 from the mobile deployment station 130 to the delivery location 180. For example, as discussed above, unmanned mobile locker data may include a total number of unmanned mobile lockers 110 located at (e.g., coupled to docking ports 135 of) the mobile deployment station 130; a charge level of each of the unmanned mobile lockers 110; and inventory retained in and/or load carrying capacity of the unmanned mobile lockers 110 located at the mobile deployment station 130. In one aspect, the control circuit 210 of the computing device 150 is programmed to select, from the unmanned mobile lockers 110 at the mobile deployment station 130, an unmanned mobile locker 110 having a charge level, storage capacity, and/or product storage conditions best suited to accommodate the products 190 to be delivered to the delivery location 180.

In some embodiments, after an unmanned mobile locker 110 is selected for delivering one or more products 190 to the delivery location 180, the products 190 to be delivered to the delivery location 180 are loaded into the selected unmanned mobile locker 110. In one aspect, the products 190 are loaded manually into the selected unmanned mobile locker 110 via a human operator. In another aspect, the mobile deployment station 130 is configured to automatically load the products 190 into the selected unmanned mobile locker 110. In yet another aspect, the products 190 to be delivered to the delivery location 180 are pre-loaded (e.g., at a distribution center) into the unmanned mobile locker 110 selected for delivery.

In some embodiments, the computing device 150 obtains GPS data (i.e., GPS coordinates) associated with the delivery location 180, mobile deployment station 130, and unmanned mobile locker 110. Such GPS data may be obtained by the computing device 150, for example, from the electronic database 140, or from the emitter 136 of the mobile deployment station 130, or from the emitter 116 of the unmanned mobile locker 110. In some embodiments, the computing device 150 obtains and/or determines (and sends to the electronic database 140 for storage) the identity (e.g., GPS coordinates) of the delivery location 180. As described above, the mobile deployment station 130 is equipped with an emitter 136 that is configured to transmit GPS coordinates of the mobile deployment station 130 to the computing device 150 in real-time while the mobile deployment station 130 is moving or stationary. Similarly, as described above, the unmanned mobile locker 110 is equipped with an emitter 116 that is configured to transmit GPS coordinates of the unmanned mobile locker 110 in real-time, as the unmanned mobile locker 110 is navigating on a city street after being deployed, or when the unmanned mobile locker 110 is being transported via the mobile deployment station 130 while coupled to a docking port 135 at the mobile deployment station 130. The GPS coordinates of the mobile deployment station 130 and/or unmanned mobile locker 110 may be transmitted by the emitters 136 and 116, respectively, to the computing device 150 directly, or may be transmitted for storage to electronic database 140.

In some embodiments, after obtaining the GPS coordinates of the delivery location and the mobile deployment station 130 and/or unmanned mobile locker 110, the computing device 150 determines an optimal travel route for the unmanned mobile locker 110 from the mobile deployment station 130 to the delivery location 180. In some aspects, the computing device 150 calculates multiple possible optimum routes. In some embodiments, the system 100 integrates 2D and 3D maps of the navigable space of the unmanned mobile locker 110 with physical locations of objects (e.g., trees, cars, houses, or the like) located between the mobile deployment station 130 and the delivery location 180. The 2D and 3D maps of relevant geographic locations may be downloaded in real-time or pre-stored in the electronic database 140. In one approach, after the computing device 150 maps all objects to specific locations using algorithms, measurements and global position system (GPS) geo-location, the grids may be applied sectioning off the maps into access ways and blocked sections, enabling the unmanned mobile locker 110 to use such grids for navigation and recognition. The grids may be applied to 2D horizontal maps along with 3D models. Such grids may start at a higher unit level and then can be broken down into smaller units of measure by the computing device 150 when needed to provide more accuracy.

In some embodiments, after the route of the unmanned mobile locker 110 to the delivery location 180 is determined by the computing device 150, the computing device 150 transmits a delivery control signal including delivery route instructions to the selected unmanned mobile locker 110 to deploy the selected unmanned mobile locker 110 from the mobile deployment station 130 and to guide the selected unmanned mobile locker 110 from the mobile deployment station 130 to the delivery location 180 along a delivery route determined by the computing device 150. As discussed above, in embodiments, where the unmanned mobile lockers 110 are configured as mobile mini-deployment stations that operatively couple to and to deploy therefrom one or more mini unmanned mobile lockers 111, the control circuit 210 of the computing device 150 is configured to transmit a delivery control signal to the mini unmanned lockers 111 deployed from the unmanned mobile lockers 110 such that the mini unmanned lockers 111 are guided in their navigation to the delivery location 180 via this delivery control signal. In some embodiments, the mini unmanned lockers 111 are instead guided in their navigation to the delivery location 180 via a delivery control signal transmitted by the control circuit 118 of the unmanned mobile locker 110 to the mini unmanned lockers 111. In some aspects, when the route instructions transmitted to the unmanned mobile locker 110 by the computing device 150 include an instruction to the unmanned mobile locker 110 to remain at the delivery location 180 for a predetermined interval of time (e.g., 15 minutes, 30 minutes, 1 hour, or more than 1 hour), the unmanned mobile locker 110 is configured to remain at the delivery location for the period of time indicated in the route instructions, and an electronic notification transmitted by the computing device 150 to an electronic device of the intended delivery recipient includes an indication of the interval of time that the unmanned mobile locker 110 will wait at the delivery location 180 for the intended recipient to retrieve the product 190 from the cargo space 119 of the unmanned mobile locker 110. It will be appreciated that the route instructions, after being determined by the computing device 150 and transmitted to the unmanned mobile locker 110, can be recalculated by the computing device 150 in real-time, for example, if an obstacle or another movement restriction is detected along the originally calculated route of the unmanned mobile locker 110, or if the route is changed for another reason.

In some embodiments, after the unmanned mobile locker 110 arrives to the delivery location 180, the unmanned mobile locker 110, which is already programmed with the GPS coordinates of the delivery location 180 based on the delivery control signal received from the computing device 150, the sensor 114 of the unmanned mobile locker 110 scans for the presence of available charge ports (e.g., docking stations) where the unmanned mobile locker 110 may be recharged. In one aspect, the sensor 114 of the unmanned mobile locker 110 scans for the presence of other unmanned mobile lockers 110 at or near the delivery location 180, and if another unmanned mobile locker 110 is detected nearby, two (or more) unmanned mobile lockers 110 may couple to each other for recharging (and for communication) purposes.

In some embodiments, after arriving at the delivery location 180, the unmanned mobile locker 110 transmits, via the emitter 116 over the network 125, a signal including an electronic confirmation that the product 190 has been delivered by the unmanned mobile locker 110 to the designated delivery location 180. In one approach, such an electronic confirmation is sent directly to the computing device 150, although the electronic confirmation may be instead sent to the electronic database 140 for retrieval by the computing device 150. In some embodiments, after receipt from the unmanned mobile locker 110 of such an electronic confirmation, the computing device 150 transmits an electronic notification to an electronic device (e.g., mobile phone, tablet, etc.) of the intended delivery recipient to notify the intended delivery recipient that the product 190 has arrived at the delivery location 180.

In some embodiments, the electronic notification transmitted by the computing device 150 to the electronic device of the intended recipient includes a verification code that the intended recipient would be required to provide to the unmanned mobile locker 110 (either via the electronic device of the intended recipient or by manually entering via an interface of the unmanned mobile locker 110) in order to gain access to the cargo space 119 of the unmanned mobile locker 110. As described above, instead of a verification code that must be entered or otherwise transmitted by the intended recipient, the unmanned mobile locker 110 according to some embodiments is equipped with a sensor 114 configured to detect biometric data associated with the intended delivery recipient, enabling the verification of the intended recipient via the biometric data detected by the sensor 114. As described above, the unmanned mobile locker 110, in response to either a control signal from the computing device 150, or a verification code or biometric data entered by the intended recipient, permits the intended recipient to retrieve the product 190 from the cargo space 119 of the unmanned mobile locker 110.

For example, after the intended delivery recipient attempting to retrieve the product 190 from the cargo space 119 of the unmanned mobile locker 110 is authenticated as an authorized person, the unmanned mobile locker 110 either opens the cargo space 119 to permit this person to remove the product 190 from the cargo space 119, or ejects the product 190 from the cargo space 119 without opening the cargo space 119 to access by this person. In addition, in some configurations, the emitter 116 of the unmanned mobile locker transmits, via the network 125, a signal including an electronic confirmation that the product 190 has been retrieved from the cargo space 119 of the unmanned mobile locker 110 by an authorized person at the delivery location 180. In one approach, in response to receipt of such an electronic confirmation from the unmanned mobile locker 110, the computing device 150 transmits a return control signal including return route instructions to the unmanned mobile locker 110 to guide the unmanned mobile locker 110 back to the mobile deployment station 130.

After receipt of the return control signal, the unmanned mobile locker 110 navigates back to the mobile deployment station 130 (which may remain at the location from which the unmanned mobile locker 110 was deployed, or which may be at a different location) based on the return route instructions in the return control signal. In some embodiments, in response to receipt of the electronic confirmation from the unmanned mobile locker 110 that a verified person retrieved the product(s) 190 from the unmanned mobile locker 110, the computing device 150 transmits a signal to the electronic database 140 indicating that the order to have the product(s) 190 delivered to the delivery location 180 has been successfully completed. It will be appreciated that the return route instructions contained in the return control signal need not necessarily instruct the unmanned mobile locker 110 to return directly to the mobile deployment station 130, and may instead direct the unmanned mobile locker 110 to go to another delivery location prior to returning to the mobile deployment station 130. After receipt of the return control signal, the unmanned mobile locker 110 navigates back to the mobile deployment station 130 (which may remain at the location from which the unmanned mobile locker 110 was deployed, or which may be at a different location) based on the return route instructions in the return control signal.

The systems and methods described herein advantageously allow retailers to conveniently deliver products to various delivery destinations via mobile lockers that securely retain the products therein. Such systems and methods provide a significant convenience for the intended delivery recipients and are likely to increase customer loyalty to the retailer. In addition, such systems and methods provide the retailers with significant operation cost savings, since deliveries are made via unmanned mobile lockers that do not require a human operator.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for delivering products to delivery locations via unmanned mobile lockers, the system comprising:
a deployment station configured to operatively couple to the unmanned mobile lockers;
a plurality of unmanned mobile lockers configured to transport at least one product ordered to be delivered from the deployment location to a delivery location;
an electronic database including:
order data indicating the at least one product ordered to be delivered and the delivery location; and
unmanned mobile locker data indicating one or more of the unmanned mobile lockers available to deliver the at least one product to the delivery location;
a computing device including a processor-based control circuit configured to:
obtain the order data and the unmanned mobile locker data from the electronic database;
select, based on the obtained order data and the unmanned mobile locker data, an unmanned mobile locker from the plurality of unmanned mobile lockers at the deployment station to deliver the at least one product ordered to be delivered to the delivery location;
transmit a delivery control signal to the selected unmanned mobile locker, the delivery control signal including delivery route instructions to guide the selected unmanned mobile locker from the deployment station to the delivery location along a delivery route determined by control circuit of the computing device; and
transmit a return control signal to the selected unmanned mobile locker, the return control signal including return route instructions to guide the selected unmanned mobile locker from the delivery location to the deployment station along a return route determined by control circuit of the computing device.

2. The system of claim 1, wherein the deployment station includes a plurality of docking ports configured to permit respective ones of the unmanned mobile lockers to dock thereto and charge, and wherein each of the unmanned mobile lockers is configured to operatively couple to one or more mini unmanned mobile lockers configured to be retained in a cargo space of the unmanned mobile lockers and to be deployed from the cargo space of the unmanned mobile lockers in order to deliver the at least one product to the delivery location.

3. The system of claim 1, wherein each of the unmanned mobile lockers includes a lockable cargo space configured to retain the at least one product, wherein the lockable cargo space is configured to be unlocked in response to a verification input by an authorized person at the delivery location, and wherein the verification input comprises a verification code, a biometric scan, and a verbal password.

4. The system of claim 3, wherein each of the unmanned mobile lockers includes a transceiver, the transceiver configured to transmit the verification input entered by the authorized person at the delivery location to the computing device, and wherein the control circuit of the computing device is configured to authenticate the authorized person based on the verification input received by the computing device from the selected unmanned mobile locker.

5. The system of claim 4, wherein the control circuit of the computing device is configured to transmit an access signal to the selected mobile locker indicating that the verification input entered by the authorized person was accepted, and wherein the selected unmanned mobile locker, in response to receipt of the access signal from the computing device, is configured to unlock the lockable cargo space and permit the authorized person to retrieve the at least one product therefrom.

6. The system of claim 5, wherein the transceiver of the selected unmanned mobile locker is configured to transmit to the computing device a confirmation signal including an electronic notification that the at least one product has been retrieved from the lockable cargo space by the authorized person, and wherein, in response to receipt of the confirmation signal from the selected unmanned mobile locker, the control circuit of the computing device is configured to transmit the return control signal to the unmanned mobile locker.

7. The system of claim 1, wherein the selected unmanned mobile locker includes a transceiver configured to transmit GPS coordinates of the physical location of the selected unmanned mobile locker to the computing device, and wherein the computing device is configured to obtain the GPS coordinates of the physical location of the selected unmanned mobile locker based on the GPS coordinates transmitted to the computing device from the transceiver of the selected unmanned mobile locker.

8. The system of claim 7, wherein the deployment station includes a transceiver configured to transmit GPS coordinates of the physical location of the deployment station to the computing device, and wherein the computing device is configured to obtain the GPS coordinates of the physical location of the deployment station based on the GPS coordinates transmitted to the computing device from the transceiver of the deployment station.

9. The system of claim 8, wherein the control circuit of the computing device is configured to generate the return routing instructions based on the obtained GPS coordinates of the physical location of the selected unmanned mobile locker and based on the obtained GPS coordinates of the physical location of the deployment station, and wherein the selected unmanned mobile locker, after receipt of the return control signal including the return route instructions from the computing device, is configured to navigate to the deployment station based on the return route instructions.

10. The system of claim 1, wherein each of the unmanned mobile lockers includes at least one of a sensor configured to detect a gas associated with a perishable product and indicating that the perishable product retained in the selected unmanned mobile locker is spoiled, and a sensor configured to generate an alert indicating that a storage temperature of the perishable product in the in the selected unmanned mobile locker is outside of an acceptable storage temperature for the perishable product.

11. A method of delivering products to delivery locations via unmanned mobile lockers, the method comprising:
providing a deployment station configured to operatively couple to the unmanned mobile lockers;
providing a plurality of unmanned mobile lockers configured to transport at least one product from the deployment location to a delivery location;
providing an electronic database including:
order data indicating the at least one product ordered to be delivered and the delivery location; and
unmanned mobile locker data indicating one or more of the unmanned mobile lockers available to deliver the at least one product to the delivery location;
providing a computing device including a processor-based control circuit configured to:
obtain the order data and the unmanned mobile locker data from the electronic database;
select, based on the obtained order data and the unmanned mobile locker data, an unmanned mobile locker from the plurality of unmanned mobile lockers at the deployment station to deliver the at least one product ordered to be delivered to the delivery location;
transmit a delivery control signal to the selected unmanned mobile locker, the delivery control signal including delivery route instructions to guide the selected unmanned mobile locker from the deployment station to the delivery location along a delivery route determined by control circuit of the computing device; and
transmit a return control signal to the selected unmanned mobile locker, the return control signal including return route instructions to guide the selected unmanned mobile locker from the delivery location to the deployment station along a return route determined by control circuit of the computing device.

12. The method of claim 11, further comprising providing the deployment station with a plurality of docking ports configured to permit respective ones of the unmanned mobile lockers to dock thereto and charge, and further comprising configuring each of the unmanned mobile lockers to operatively couple to one or more mini unmanned mobile lockers configured to be retained in a cargo space of the unmanned mobile lockers and to be deployed from the cargo space of the unmanned mobile lockers in order to deliver the at least one product to the delivery location.

13. The method of claim 11, further comprising:
providing each of the unmanned mobile lockers with a lockable cargo space configured to retain the at least one product; and
unlocking the lockable cargo space in response to a verification input by an authorized person at the delivery location, wherein the verification input comprises a verification code, a biometric scan, and a verbal password.

14. The method of claim 13, further comprising:
providing each of the unmanned mobile lockers with a transceiver configured to transmit the verification input entered by the authorized person at the delivery location to the computing device; and
authenticating, via the control circuit of the computing device, the authorized person based on the verification input received by the computing device from the selected unmanned mobile locker.

15. The method of claim 14, further comprising:
transmitting, via the control circuit of the computing device, an access signal to the selected mobile locker indicating that the verification input entered by the authorized person was accepted; and
unlocking, in response to receipt of the access signal from the computing device, the lockable cargo space to permit the authorized person to retrieve the at least one product therefrom.

16. The method of claim 15, further comprising:
Transmitting, via the transceiver of the selected unmanned mobile locker, to the computing device, a confirmation signal including an electronic notification that the at least one product has been retrieved from the lockable cargo space by the authorized person; and
transmitting, via the control unit of the computing device and in response to receipt of the confirmation signal from the selected unmanned mobile locker, the return control signal to the unmanned mobile locker.

17. The method of claim 11, further comprising:
providing the selected unmanned mobile locker with a transceiver configured to transmit GPS coordinates of the physical location of the selected unmanned mobile locker to the computing device; and
obtaining, via the computing device, the GPS coordinates of the physical location of the selected unmanned mobile locker based on the GPS coordinates transmitted to the computing device from the transceiver of the selected unmanned mobile locker.

18. The method of claim 17, further comprising:
providing the deployment station with a transceiver configured to transmit GPS coordinates of the physical location of the deployment station to the computing device; and
obtaining, via the computing device, the GPS coordinates of the physical location of the deployment station based on the GPS coordinates transmitted to the computing device from the transceiver of the deployment station.

19. The method of claim 18, further comprising:
Generating, via the control circuit of the computing device, the return routing instructions based on the obtained GPS coordinates of the physical location of the selected unmanned mobile locker and based on the obtained GPS coordinates of the physical location of the deployment station; and
navigating, via the selected unmanned mobile locker and after receipt of the return control signal including the return route instructions from the computing device, to the deployment station based on the return route instructions.

20. The method of claim 11, further comprising providing each of the unmanned mobile lockers with at least one of a sensor configured to detect a gas associated with a perishable product and indicating that the perishable product retained in the selected unmanned mobile locker is spoiled, and a sensor configured to generate an alert indicating that a storage temperature of the perishable product in the in the selected unmanned mobile locker is outside of an acceptable storage temperature for the perishable product.
